(19) United States
(12) Patent Application Publication
(10) Pub. No.: US 2015/0360333 A1
(43) Pub. Date: Dec. 17, 2015

(54) METHOD OF FABRICATING A TUBE FOR AN EVAPORATOR

(71) Applicant: MAHLE International GmbH, Stuttgart (DE)

(72) Inventors: SOURAV CHOWDHURY, LOCKPORT, NY (US); PRASAD S. KADLE, WILLIAMSVILLE, NY (US)

(21) Appl. No.: 14/734,148

(22) Filed: Jun. 9, 2015

Related U.S. Application Data
(63) Continuation-in-part of application No. 13/107,045, filed on May 13, 2011.
(60) Provisional application No. 61/346,522, filed on May 20, 2010.

(51) Int. Cl. B23P 15/26; F28F 1/02; F28D 1/03

(52) U.S. Cl. CPC B23P 15/26; F28D 1/0391; F28F 1/022

(57) ABSTRACT

A method of fabricating a folded evaporator tube includes providing a tube with a plurality of webs extending between interior surfaces of the tube. The webs are oriented at an angle between forty-five degrees (45°) and sixty degrees (60°) of angle relative to a bottom wall of the tube. A cutting-device that includes a knife and a guide that cooperate to cut the tube to a desired length is also provided. The knife has a point that is forced in a direction parallel to a wall of the tube. The guide defines an opening that conforms to the tube to maintain the shape of the tube during cutting by the knife. The knife further defines a bottom and top edges that extend away from the point and cooperates with the opening to shear the bottom and top walls of the tube along with internal webs inside the tube.

### CROSS-REFERENCE TO RELATED APPLICATION

This application is a continuation-in-part application and claims the benefit of U.S. patent application Ser. No. 13/107,045, entitled FABRICATED TUBE FOR AN EVAPORATOR, and filed on 13 May 2011, which claims the benefit under 35 U.S.C. §119(e) of U.S. Provisional Patent Application Ser. No. 61/346,522 for a FABRICATED TUBE EVAPORATOR, filed on May 20, 2010, which is hereby incorporated by reference in its entirety.

### TECHNICAL FIELD OF INVENTION

The present invention relates generally to a method to fabricate a tube for a heat exchanger, and more specifically a tube configuration most appropriate for cutting with a particular cutting device.

### BACKGROUND OF INVENTION

A heat exchanger assembly such as a radiator, condenser, or evaporator for use in a motor vehicle typically includes an inlet header, an outlet header, a plurality of tubes hydraulically connecting the headers for fluid flow therebetween, and external fins interconnecting the tubes. The headers, tubes, and fins are typically assembled into a unitary structure and brazed to form the heat exchanger assembly.

A first heat transfer fluid, such as a liquid coolant, flows from the inlet header to the outlet header through the plurality of tubes. The first heat transfer fluid is in contact with the interior surfaces of the tubes while a second heat transfer fluid, such as ambient air, is in contact with the exterior surfaces of the tubes. Where a temperature difference exists between the first and second fluids, heat is transferred from the higher temperature fluid to the lower temperature fluid through the walls of the tubes. It is known that by providing internal webs within the passageways of the tubes, the surface area available for heat transfer between the fluid and the tube wall will increase. Also, these webs will improve the structural strength of the tubes as the fluid inside the tube is pressurized. The internal webs extend substantially the length of the tubes and define a plurality of channels or ports for the flow of a heat transfer fluid between the headers.

A known method of forming multi-port tubes is by folding a sheet of pliable heat conductive material. Typically, a flat elongated sheet of metallic material is folded to form a tube having multiple ports defined by internal corrugated folds. The internal corrugated folds form the internal webs that define the shape and size of the ports. Such a tube geometry can also be achieved by extrusion. However, folded tubes provide several advantages over extruded tubes in terms of lower cost and ease of manufacturing for the tube itself as well as for the final assembly of the heat exchanger. One significant advantage is that a folded tube can be formed from a sheet of clad aluminum that offers superior corrosion resistance without the need for applying additional coatings. Extrusion technology cannot readily create tubes with external clad layer and hence to achieve equivalent corrosion resistance, a separate coating operation is required which increases cost and also which is not environmentally benign. Another advantage is that due to the presence of cladding on the tube, other components of the heat exchanger, such as the headers and air fins, need not be cladded, thereby simplifying the material system for corrosion protection. A further advantage is that since the headers do not need to be cladded, the headers can be formed with extrusion technology to reduce the cost of manufacturing.

It is advantageous if the tube is formed in a continuous process so that a tube of any desired length can be made with minimal material waste and minimal operational time. However, the angles between the webs and the exterior surfaces that provide the most appropriate thermal and flow performance may not be the same as the angles that will be preferable for cutting the tube to a required length with a given cutting device.

### SUMMARY OF THE INVENTION

In accordance with one embodiment, a method of fabricating a folded evaporator tube is provided. The method includes the step of providing a tube formed from at least one strip of heat conductive material folded such that the tube has a cross section that defines a bottom wall with two opposing edges transitioning into a top wall spaced apart from the bottom wall to define an interior surface that surrounds a corrugated portion formed of a plurality of webs extending between and in contact with the interior surface. The webs are oriented at an angle between forty-five degrees (45°) and sixty degrees (60°) of angle relative to the bottom wall. The method also includes the step of providing a cutting-device that includes a knife and a guide that cooperate to cut the tube to a desired length. The knife defines a point oriented to first pierce a first edge of the two opposing edges as the point is forced in a direction parallel to the bottom wall along a line between the bottom wall and the top wall. The guide defines an opening that conforms to the tube to maintain the shape of the tube during cutting of the tube by the knife. The knife further defines a bottom edge that extends away from the point and cooperates with the opening to shear the bottom wall of the tube during cutting of the tube by the knife, and a top edge that extends away from the point and cooperates with the opening to shear the top wall of the tube during cutting of the tube by the knife. The method also includes the step of moving the knife so after piercing the first edge the point successively pierces each of the plurality of webs followed by a second edge of the two opposing edges opposite the first edge.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a perspective view of an evaporator having two banks of folded tubes for a motor vehicle;

FIG. 1A is a detail view of tubes of the evaporator of FIG. 1;

FIGS. 2A-E show the intermediate stages in the formation of the folded tube for the evaporator of FIG. 1;

FIG. 3 is a cross-section of a folded tube having geometric features of the present invention;

FIG. 4 is an isometric view of a cutting device for cutting the tube of FIG. 3 in accordance with one embodiment;

FIG. 5 is a sectional view of a cutting device for cutting the tube of FIG. 3 in accordance with one embodiment; and

FIG. 6 is a flowchart of a method of fabricating the folded evaporator tube of FIG. 3 in accordance with one embodiment.

### DETAILED DESCRIPTION

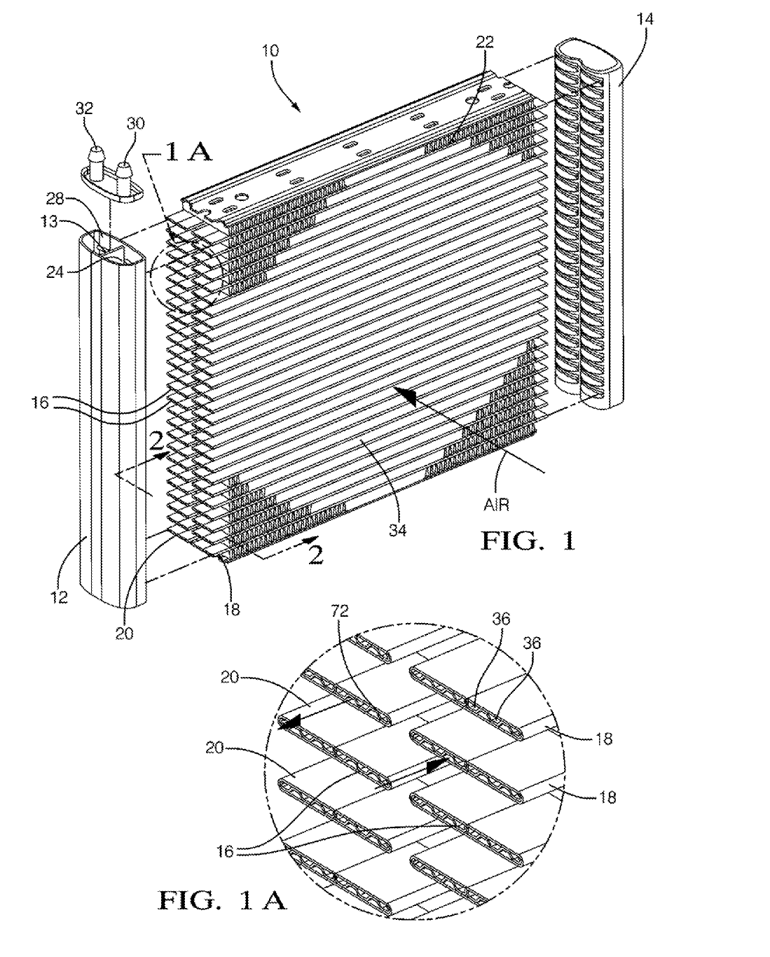

FIGS. 1 through 3, wherein like numerals indicate corresponding parts throughout the views, illustrate a non-limiting example of an evaporator 10 equipped with folded tubes, hereafter referred to as the tube 16, with features that improve the operating characteristics of the evaporator 10 and how the tube 16 is cut to a desired length. Shown in FIG. 1 is a perspective view of an evaporator 10 having dual banks including a first bank 18 and a second bank 20 that each include multiples of the tube 16 for use in a motor vehicle. The evaporator 10 is typically housed in a Heating Ventilation and Air Conditioning (HVAC) module of a motor vehicle and includes multiples of the tube 16 hydraulically connecting two spaced apart headers, hereafter referred to as the first header 12, and the second header 14 suitable configured for two-phase refrigerant to flow therebetween. By way of example, the first header 12 is typically an inlet/out let header defining a cavity that includes a substantially centered partition 24 extending the length of the first header 12 which separates a cavity defined by the first header into an inlet chamber 26 and an outlet chamber 28. The inlet chamber 26 is in hydraulic communication with an inlet port 30 and the outlet chamber 28 is in hydraulic communication with an outlet port 32. The first bank 18 of substantially parallel arrangement of multiples of the tube 16 that hydraulically connects the inlet chamber 26 to the second header 14 and a second bank 20 of multiples of the tube 16 that connects the second header 14 to the outlet chamber 28. Fins 22 are disposed between and thermally interconnect the multiples of the tube 16 to increase the surface area available for heat transfer from the external fluid (air). The multiples of the tube 16 and the fins 22 together define the core 34 of the evaporator 10 through which ambient air flows.

During normal operating conditions, a partially expanded two-phase refrigerant flows into the inlet chamber 26 of the first header (inlet/outlet header) by way of the inlet port 30 and continues through the first bank 18 of tube 16 to the second header (return header) 14. From the second header 14, the two-phase refrigerant flows through the second bank 20 of multiples of the tube 16 to the outlet chamber 28 of the first header 12 and exits the outlet port 32. As the two-phase refrigerant flows through the tube 16, the two-phase refrigerant continues to expand into a vapor phase by absorbing heat from the ambient air. To further increase the heat transfer efficiency, the tube 16 includes internal geometric features having specific critical parameters that provide for improved performance of the evaporator 10.

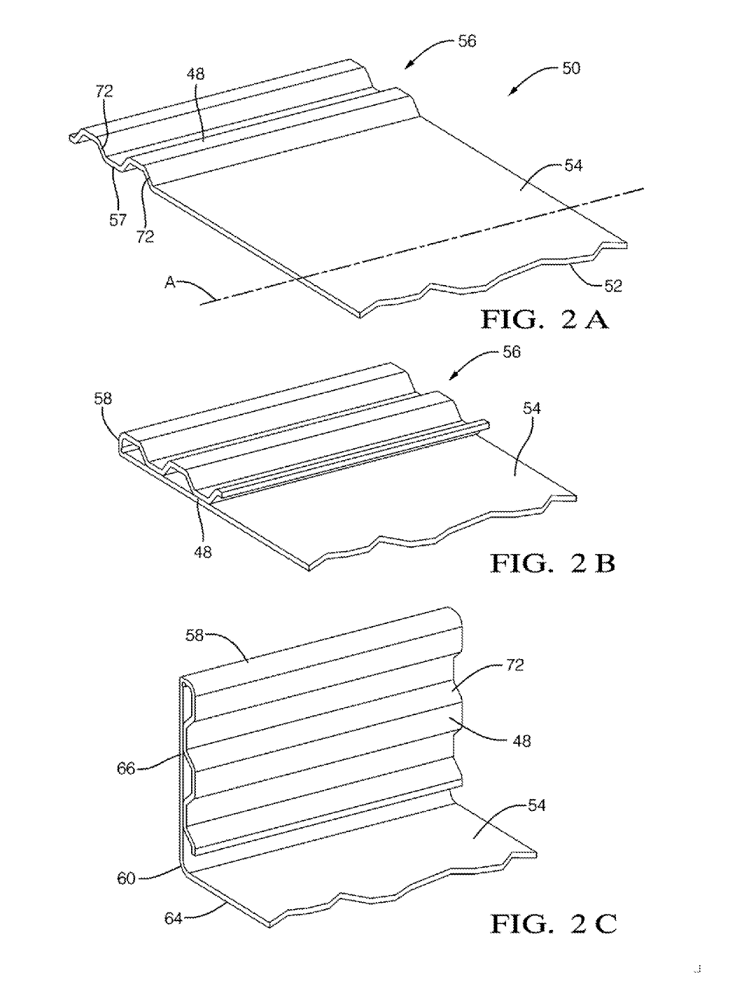

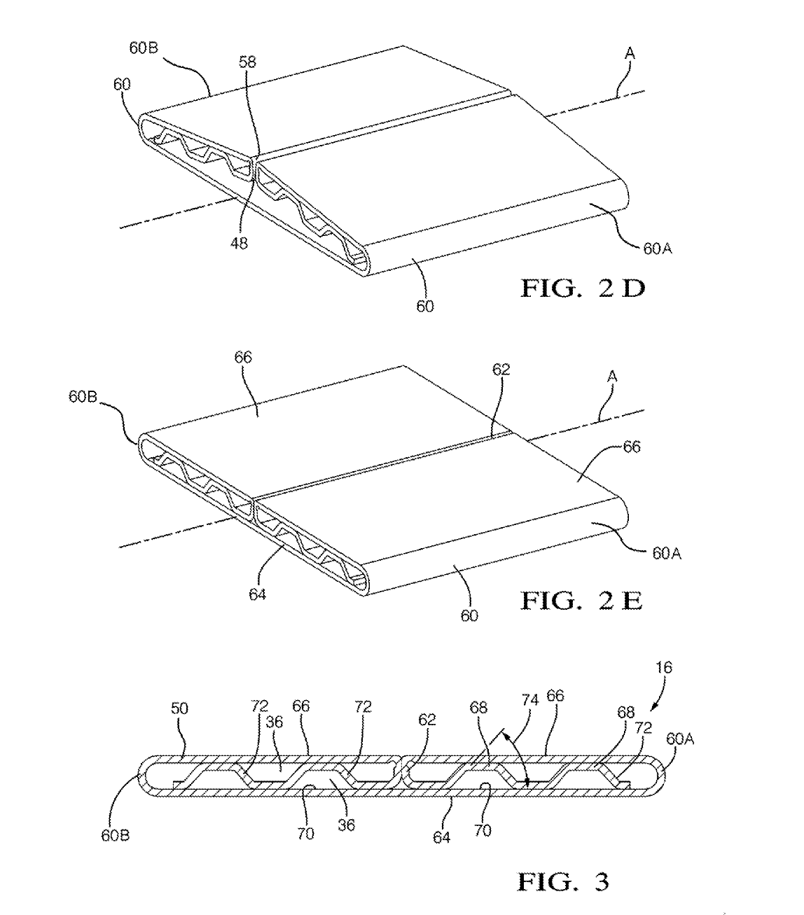

FIG. 1A illustrates a view of the evaporator 10 of FIG. 1 at detail section 1A. FIG. 1A shows dual banks of a folded implementation of the tube 16. The tube 16 shown is typically formed by folding a sheet of heat conductive material to define a series of internal channels 36 for refrigerant flow. The channel walls, hereafter referred to as the webs 72, are formed by the folding of the sheet of heat conductive material and act as internal extended surfaces to increase the area available for heat transfer. FIGS. 2A-E show the typical stages in the formation of the tube 16.

FIG. 2A illustrates a partial sheet or strip of heat conductive material 50, preferably a continuous cladded aluminum strip, having a first surface 52 and a second surface 54 extending along a longitudinal A-axis. The heat conductive material 50 is longitudinally fed into a multi-station roll forming apparatus having pairs of rollers arranged to plastically deform the strip of the heat conductive material 50 to form a corrugated portion 56 symmetrically on both sides of the A-axis. Each of the corrugated portions 56 includes a series of alternating crests 48 and joining segments, i.e. the webs 72. The alternating crests 48 may be defined by sharp edges on both sides to substantially flat surfaces that correspond to the first surface 52 and the second surface 54 of the heat conductive material 50, the significance of which will be discussed below.

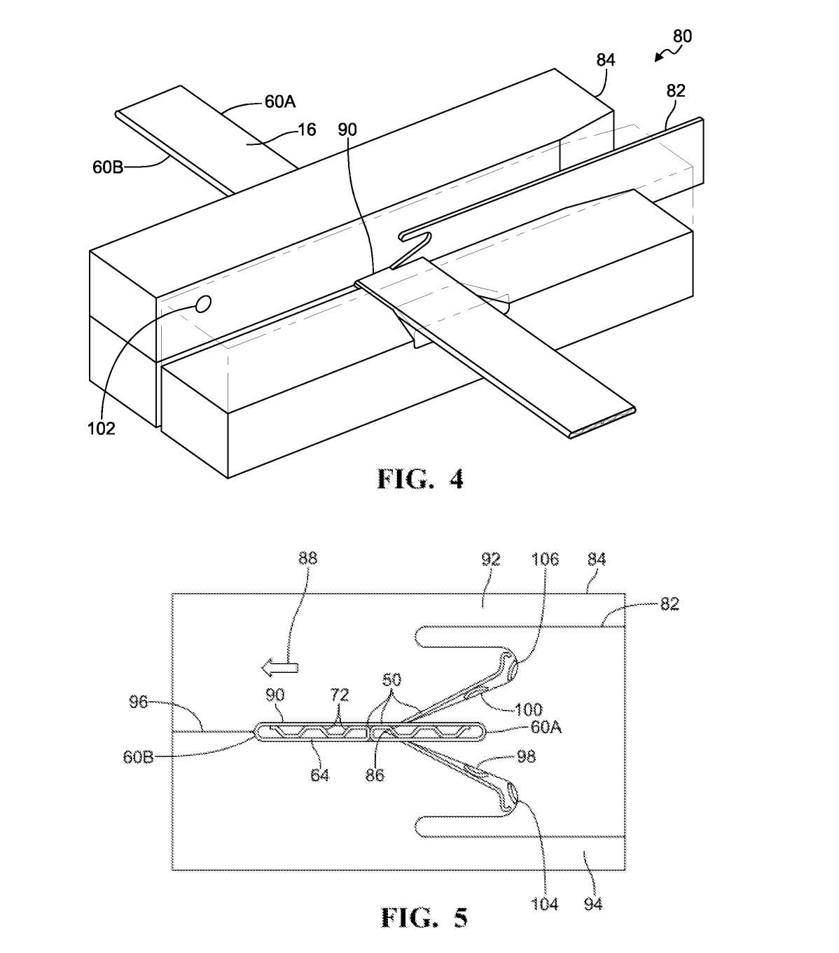

Intermediate stations in the roll forming apparatus successively further deform the heat conductive material 50 to the intermediate configuration shown in FIG. 2B. The corrugated portion 56 is folded inward toward the second surface 54 such that the alternating crests 48 on the same side as the second surface 54 are oriented toward and are in contact with the second surface 54. The fold of the corrugated portion 56 defines an abutting surface 58. The corrugated portion 56 is folded again toward the second surface 54 such that a portion of the first surface 52 defines two opposing edges 60 symmetrically on side of the tube as shown in FIGS. 2C and 2D. The abutting surfaces 58 of the corrugated portion 56 on either side of the A-axis are abutted upon each other and brazed forming the tube 16 having a center seam that runs the length of the tube 16 as shown in FIG. 2E. On leaving the roll forming apparatus, the tube 16 emerges as a continuous part which is cut to the desired length using a cutting-device 80 (FIGS. 4-5) that will be described in more detail later.

FIG. 3 illustrates a cross sectional view of the folded-B version of the tube 16 of FIGS. 2A-E having a central wall 62, two opposing edges 60, hereafter the first edge 60A and the second edge 60B, a bottom wall 64, and a pair of top walls, hereafter referred to as the top wall 66. The tube 16 also has internal horizontal flange segments 68, defined by the alternating crests 48 (FIG. 2B) of folded sections of the heat conductive material 50, abutting the interior surface 70 of the folded tube and transitioning to channel walls defined by the webs 72. As disclosed herein, the center wall 62, the first edge 60A, the second edge 60B, the bottom wall 64, top wall 66, and corrugated portions 56 are formed by folding a continuous strip of clad aluminum that is the heat conductive material 50. The terms “bottom”, “upper”, and “horizontal” are arbitrary, as the evaporator tube could be in any orientation. Likewise, the center wall 62 need not be exactly in the center of the width of the tube cross section, but typically will be.

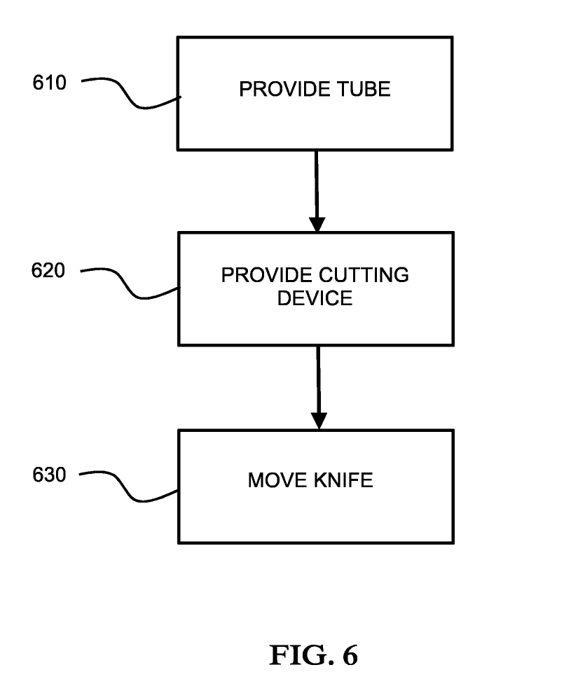

FIG. 6 illustrates a non limiting example of a method 600 of fabricating a folded evaporator tube, e.g. the tube 16 illustrated in FIGS. 1-3, using the cutting device 80 illustrated in FIGS. 4-5.

Step 610, PROVIDE TUBE, may include providing the tube 16 formed from at least one strip of heat conductive material 50 folded so the tube 16 has a cross section that defines the bottom wall 64 with two opposing edges 60 transitioning into a top wall 66 spaced apart from the bottom wall 64 to define the interior surface 70 that surrounds a corrugated portion formed of a plurality of the webs 72 extending between and in contact with the interior surface 70.

A previous thermal performance analysis of a non-limiting example of the tube 16 fabricated from a 0.26 mm thick strip of the heat conductive material 50 with a width of 17.6 mm between the two opposing edges 60, and a height of 1.4 mm indicated that optimum thermal performance was provided when the webs 72 are oriented at an angle 74 of 41.5 degrees of angle between the channel wall 72 and the interior surface 70, i.e. relative to the bottom wall 64 or the top wall 66. However, as will be explained in more detail below, it was discovered that the quality of the cut end of the tube 16 is improved when the webs 72 are oriented at the angle 74 between forty-five degrees (45°) and sixty degrees (60°) of angle relative to the bottom wall 64 or the top wall 66. The thermal performance and other characteristics of the tube 16 are minimally compromised by forming the tube 16 with the angle 74 of 45° to 60°.

Step 620, PROVIDE CUTTING DEVICE, may include providing the cutting-device 80 (FIGS. 4-5) that includes a knife 82 and a guide 84 that together cooperate to cut the tube 16 to a desired length suitable for forming a particular configuration of the evaporator 10.

The knife 82 includes or defines a point 86 that is oriented relative to the tube 16 to first pierce a first edge 60A of the two opposing edges 60 as the point 86 is forced in a direction 88 parallel to the bottom wall 64 along a line between the bottom wall 64 and the top wall 66.

The guide 84 is configured to define an opening 90 that conforms to the exterior cross section shape of the tube 16 in order to maintain the shape of the tube 16 during cutting of the tube 16 by the knife 82. In this non-limiting example, the guide 84 is bisected horizontally so that the guide 84 includes an upper portion 92 and a lower portion 94 that cooperate to define the opening 90. The guide 84 may be further configured so that the upper portion 92 and the lower portion 94 are operable, i.e. can be moved relative to one another, into an open position (not shown) where the upper portion 92 and the lower portion 94 are spaced apart so the tube 16 can be easily fed through the opening 90. As shown in FIGS. 4 and 5, the guide 84 may also be operable to a clamped position 96 where the upper portion 92 and the lower portion 94 are forced together so tube 16 is held in place and the shape of the tube 16 is maintained during the step 630 describe below of moving the knife 82 to cut the tube 16.

The knife 82 may be further configured to define a bottom edge 98 that extends away from the point 86. The bottom edge 98 is configured to cooperate with the opening 90 to shear the bottom wall 64 of the tube 16 during cutting of the tube 16 by the knife 82 in cooperation with the guide 84. As used herein, the term ‘shear’ is used to describe a scissor like cutting action provided by the bottom edge 98 being in very close proximity, preferably less than 0.03 mm, or optimally in sliding contact with a face 102 of the guide 84 that defines the opening 90. Similarly, the knife 82 may include or define a top edge 100 that extends away from the point 86 and cooperates with the opening 90 to shear the top wall 66 of the tube 16 during cutting of the tube 16 by the knife 82 in cooperation with the guide 84.

The bottom edge 98 of the knife 82 may advantageously transition into a bottom curved portion 104 configured to accumulate chips or pieces of the heat conductive material 50 removed or cut-away from the tube 16 by the bottom edge 98 in cooperation with the guide 84. In other words, the bottom curved portion 104 curls and redirects the heat conductive material 50 removed from the tube by the bottom edge 98 away from the cutting area where the bottom edge 98 and the opening 90 intersect. Similarly, the top edge 100 of the knife 82 may be configured to transition into a top curved portion 106 configured to accumulate chips or pieces of the heat conductive material 50 removed from the tube by the top edge 100 in cooperation with the guide 84. Advantageously, the length of the knife 82 may be such that the knife 82 can be moved in the direction 88 far enough so the bottom curved portion 104 and the top curved portion 106 emerge from the guide 84 so that the chips can be removed by, for example, a blast of compressed air.

Step 630, MOVE KNIFE, may include moving the knife 82 in the direction 88 so after piercing the first edge 60A the point 86 successively pierces each of the plurality of webs 72 and the center wall 62 followed by piercing the second edge 60B of the two opposing edges 60 opposite the first edge 60A. The linear movement of the knife 82 in the direction 88 may be achieved by various mechanical means as will be familiar to those in the machine design arts.

Accordingly, a method of fabricating a folded evaporator tube (the tube 16) is provided. It was discovered that if the angle 74 is less than about 45°, the webs 72 could deflect the point 86 of the knife 82 and cause the cut edges of the heat conductive material 50 to be irregular, i.e.—ragged. Also, if the angle 74 is less than about 45°, the pointed end of the knife does not collide with the webs head-on; instead it contacts the webs at a shallow angle and the webs tends to glide along the knife edge. This issue is found to result in a deformity of the outer ports at the two opposing edges 60. The end port of the leading end of the tube 16 (the first edge 60A) is significantly enlarged due to the last web getting pushed in. Also, the port at the trailing end of the tube (the second edge 60B) is deformed such that the tail end of the strip is curled up. Also, the webs 72 of the tube 16 are also slightly deformed as a result. By keeping the angle greater than 45°, deformation of the tube 16 on the cut end of the tube 16 is reduced.

While this invention has been described in terms of the preferred embodiments thereof, it is not intended to be so limited, but rather only to the extent set forth in the claims that follow.

We claim:

1. A method of fabricating a folded evaporator tube, said method comprising:
providing a tube formed from at least one strip of heat conductive material folded so the tube has a cross section that defines a bottom wall with two opposing edges transitioning into a top wall spaced apart from the bottom wall to define an interior surface that surrounds a corrugated portion formed of a plurality of webs extending between and in contact with the interior surface, wherein the webs are oriented at an angle between forty-five degrees (45°) and sixty degrees (60°) of angle relative to the bottom wall;
providing a cutting-device that includes a knife and a guide that cooperate to cut the tube to a desired length, wherein the knife defines a point oriented to first pierce a first edge of the two opposing edges as the point is forced in a direction parallel to the bottom wall along a line between the bottom wall and the top wall, wherein the guide defines an opening that conforms to the tube to maintain the shape of the tube during cutting of the tube by the knife, wherein the knife further defines a bottom edge that extends away from the point and cooperates with the opening to shear the bottom wall of the tube during cutting of the tube by the knife, and a top edge that extends away from the point and cooperates with the opening to shear the top wall of the tube during cutting of the tube by the knife; and
moving the knife so after piercing the first edge the point successively pierces each of the plurality of webs followed by a second edge of the two opposing edges opposite the first edge.

2. The method in accordance with claim 1, wherein the tube is formed from a single unitary strip of heat conductive material.

3. The method in accordance with claim 1, wherein the bottom edge of the knife transitions into a bottom curved portion configured to accumulate heat conductive material removed from the tube by the bottom edge, and the top edge of the knife transitions into a top curved portion configured to accumulate heat conductive material removed from the tube by the top edge.

4. The method in accordance with claim 1, wherein the guide includes an upper portion and a lower portion that cooperate to define the opening, wherein the upper portion and the lower portion are operable into an open position where the upper portion and the lower portion are spaced apart so the tube can be fed through the opening, and operable to a clamped position where the upper portion and the lower portion are forced together so tube is held in place during the step of moving the knife to cut the tube.
